(19) United States
(12) Patent Application Publication
(10) Pub. No.: US 2017/0168747 A1
(43) Pub. Date: Jun. 15, 2017

(54) INTELLIGENT MEMORY SUPPORT FOR PLATFORM RESET OPERATION

(71) Applicant: Intel Corporation, Santa Clara, CA (US)

(72) Inventors: Woojong Han, Phoenix, AZ (US); John V. Lovelace, Irmo, SC (US); Priscilla Y. Lam, Seattle, WA (US); Richard P. Mangold, Forest Grove, OR (US); Asher M. Altman, Bedford, MA (US); Shachi K. Thakkar, Folsom, CA (US)

(21) Appl. No.: 14/966,933

(22) Filed: Dec. 11, 2015

(51) Int. Cl. G06F 3/06; G06F 1/32

(52) U.S. Cl. CPC G06F 3/0632; G06F 3/0604; G06F 3/065; G06F 3/0673; G06F 1/3203

(57) ABSTRACT

Embodiments are generally directed to intelligent memory support for platform reset operation. An embodiment of a memory module includes a memory module controller and one or more memory banks. The memory module controller is to perform one or more internal reset processes as required for the memory module, and is to support a plurality of host platform reset processes to synchronize with the host platform.

### TECHNICAL FIELD

Embodiments described herein generally relate to the field of computer memory and, more particularly, to intelligent memory support for platform reset operation.

### BACKGROUND

A server platform will support various types of reset operations depending on the circumstances. The reset operations may include a cold reset, in which the platform is initially commencing operation, a warm reset, in which the platform is resetting from active state, and a surprise reset, in which an unexpected reset process occurs.

However, computer memory is transitioning to intelligent memory that may include its own processes and control. Because of this, there is be a need to coordinate memory operations with host operations to support the needed host platform reset operations and to minimize the additional overhead required to support new memory devices.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of operation of a memory module to support reset of host platform according to an embodiment;

FIG. 2 is a flowchart to illustrate a process for support of host reset by a memory module according to an embodiment;

FIG. 3 is an illustration of cold reset operation by a memory module according to an embodiment;

FIG. 4 illustrates download of firmware for a memory module according to an embodiment;

FIG. 5 is an illustration of warm reset support by a memory module according to an embodiment;

FIG. 6 is an illustration of surprise reset support by a memory module according to an embodiment; and

FIG. 7 is an illustration of a system including a memory to support host reset according to an embodiment.

### DETAILED DESCRIPTION

Embodiments described herein are generally directed to intelligent memory support for platform reset operation.

In some embodiments, a memory module or memory device, which may specifically include, but is not limited to, a dual in-line memory module (DIMM) or similar form of memory module, operates to handle in sync with platform/host reset. In some embodiments, the memory module, which includes an internal memory controller and internal reset functions, is to operate in a manner that maintains the reset flow for the host platform and that appears to the host to operate as a legacy memory module for reset operations.

In some embodiments, a memory module controller interacts with BIOS (basic input output system) MRC (memory reference code), executed by the CPU (central processing unit), and CPU memory controller to provide intelligent platform reset support without customization of other components or upper layer software for purposes of the platform reset support. In some embodiments, the memory module controller in within a same die as the memory device.

In some embodiments, a memory module includes internal reset operations, which may include power on reset, re-sync reset, and WDT (watchdog timer) reset, and supports such reset operations together with providing transparent support for host platform reset operations for:

(1) Cold reset;

(2) Warm reset; and

(3) Surprise reset.

In some embodiments, a memory module controller is operable to provide synchronization with a host platform for all reset flows of the host platform, including cooperating with reset flow to mimic reset operation when such operations are not occurring for the memory module. As used herein, an operation to mimic reset operation may refer to a memory module operating to provide signals to a CPU memory controller in the same manner as a memory device that is proceeding through a reset operation without actually performing such reset. Stated in another way, a process may include mimicking a reset operation without actually performing the reset. The signals provided to the CPU memory controller can include standard DIMM signals (such as standard DDR4 signals) along with special command signals over the existing command/address bus. In some embodiments, reset support utilizes hardware features of the memory module in coordination with firmware and BIOS flow to support the different types of platform resets.

In some embodiments, a memory module may operate in multiple memory operation modes, and is to provide reset support in such modes. For example, the memory module may operate in the following memory operation modes:

(1) A Memory Mode to provide volatile memory operation;

(2) App-Direct Mode to provide non-volatile main memory operation; and

(3) A Storage Mode to provide non-volatile memory in a storage device operation, in the manner of, for example, a solid state drive (SSD).

In some embodiments, from a reset perspective, a memory module may be distinguishable from other storage devices because it supports each of the three memory operation modes and because the memory module is to operate in compliance with a standard memory module (such as a DIMM) connector. In some embodiments, a reset signal for a standard memory element is not to reset a memory module as the memory module includes its own internal control, such as an SoC subsystem, unlike conventional memory devices.

In some embodiments, the memory module is operable to support the three memory operation modes in different regions at the same time, and thus the memory module is to handle platform reset in a different way depending on the memory operation modes. In some embodiments, even in circumstance when the memory module is only operated on Storage Mode, unlike conventional SSD, the memory module cannot rely on the reset pin on the memory interface as this pin is utilized for internal reset flow as well. In some embodiments, the reset pin is further to be utilized for input/output (IO) training when the host reboots itself, but not to initialize the entire memory module. Stated in another way, the IO that needs to be initialized when the platform goes through reset (or reboot, as platform reset refers rebooting of the platform is reset) is reset. The remainder of the memory module controller is not reset or rebooted, but rather reacts with CPU memory controller as if the memory modules controller is reset, using transaction based DDR memory module command/signals and SMBus commands. In some embodiments, the memory module controller, unlike an SSD controller or a standard memory device, is to comprehend different platform reset types to support all three modes of memory operation, and still be compatible with platform reset flow.

In some embodiments, a memory module controller provides a system with its own reset scheme, and the memory module controller is to be in sync with various different host system reset flows, while the reset pin for the memory module does not indicate an actual reset except for the IO itself. In some embodiments, an apparatus, system, or method addresses the issue of having two different sub-systems remain in sync in terms of platform reset support so that the platform can maintain the same reset flow as with an ordinary DIMM, wherein one subsystem is a subsystem comprised of the CPU and PCH (platform controller hub) with on-board platform controller (which are the main components controlling reset flow on the platform), while the other subsystem is the on-DIMM controller (memory module controller) with its own micro-controller and memory along with power delivery system on DIMM. In some embodiments, an apparatus, system, and process are to enable each of the memory operation modes in sync with each of the different types of platform resets. The On-DIMM controller provides the interface and behavior to the other subsystem (CPU/PCH) as such elements expect as the CPU/PCH subsystem (which may also be referred to as the main subsystem) is the subsystem that initiates reset sequence per system states. However, because the memory module controller has its own subsystem, it may not be in actual reset but rather operates to mimic expected behavior so the platform can follow through the normal reset sequence. However, this is more than simply faking operation at an interface because the on-DIMM subsystem needs to understand what each one of different reset flow means on the main subsystem.

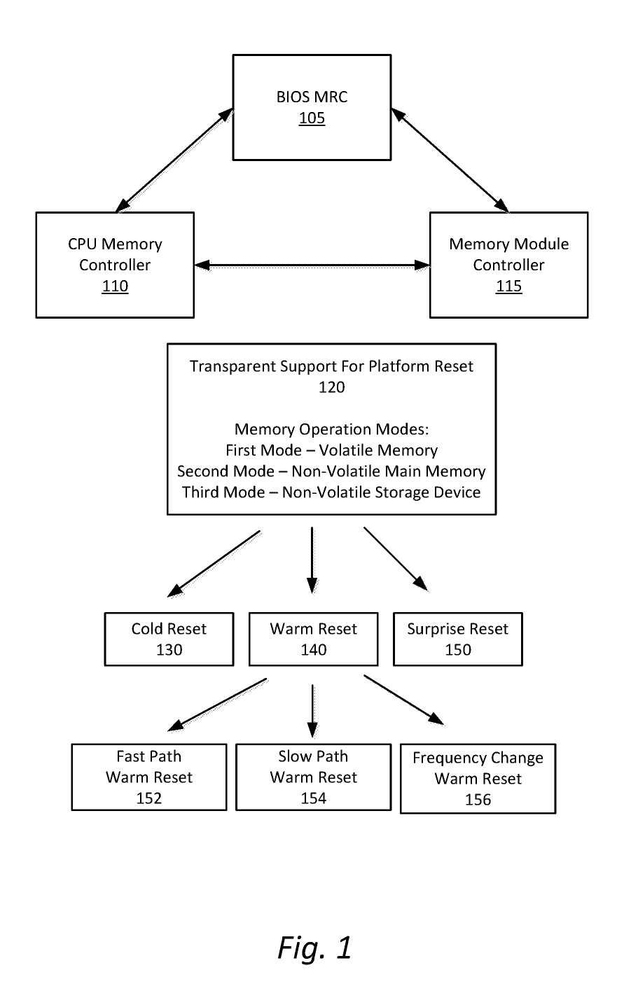

FIG. 1 is an illustration of operation of a memory module to support reset of host platform according to an embodiment. In some embodiments, an apparatus, system, or process implements reset flow within a memory module, the memory module including a memory module controller 115 having controller hardware and firmware, and supports specific interaction between a BIOS MRC 105, a CPU memory controller 110, and the memory module controller 115 in a way that the overall flow provides transparent support for platform reset 120 without customizing other components or upper layer software. CPU memory controller 110 may be an integrated memory controller (iMC) of the CPU or a memory controller separate from the CPU and operating in conjunction with the CPU. In some embodiments, the CPU memory controller 110 is operable to manage flow of data to and from computer memory, including the performance of read and write operations and refresh operations for the computer memory.

In some embodiments, transparent support for platform reset 120 is provided in each of a plurality of memory operation modes, such as the following memory operation modes:

(1) A first mode to provide volatile memory operation;

(2) A second mode to provide non-volatile main memory operation;

and

(3) A third mode to provide non-volatile memory in a storage device operation.

In some embodiments, there are three basic types of reset flow supported transparently: cold reset 130, warm reset 140, and platform surprise reset 150. In some embodiments, warm resets supported include each of a plurality of forms of a warm reset, which may be referred to as a fast path warm reset 152, a slow path warm reset 154, and a frequency change warm reset 156. Fast path warm reset 152 does not involve IO initialization, while slow path warm reset 154 and frequency change warm reset 156 may involve IO initialization. Frequency change warm reset involves changes of memory interface frequency, while slow path warm reset is limited to IO initialization with the same frequency as prior to the reset.

However, embodiments are not limited to these particular reset processes, and may operate to support any host platform reset process. In some embodiments, the memory module does not go through the host warm reset process, but supports the platform reset process by mimicking the behavior of the reset process in communications to the host platform. In some embodiments, the memory module further supports the memory module's internal reset schemes, such as own power-on reset, re-sync reset, and WDT (watchdog timer) reset.

In some embodiments, an apparatus, system, or process utilizes hardware features of the memory module in conjunction with related firmware and BIOS flow to support the different types of platform reset seen from memory controller and to provide the same reset capability as an ordinary DIMM as well as non-volatile storage without changing the platform level reset flow or other components.

For example, in various embodiments, a single DIMM card has both DRAM and (e.g., emerging) nonvolatile memory chips disposed in the DIMM card. In some embodiments, DRAM memory chips effectively act as an on board cache for the nonvolatile memory chips on the DIMM card. Ideally, the more frequently accessed cache lines of any particular DIMM card will be found on that DIMM card's DRAM chips rather than its nonvolatile memory chips. Given that multiple DIMM cards are typically plugged into a working computing system and each DIMM card is only given a section of the system memory addresses made available to the processing cores of the semiconductor chip that the DIMM cards are coupled to, the DRAM chips are acting as a cache for the nonvolatile memory that they share a DIMM card with rather than a last level CPU cache.

In other configurations, DIMM cards having only DRAM chips may be plugged into a same system memory channel (e.g., a DDR (Double Data Rate) channel) with DIMM cards having only nonvolatile system memory chips. Ideally, the more frequently used cache lines of the channel will be found in the DRAM DIMM cards rather than the nonvolatile memory DIMM cards. Thus, again, because there are typically multiple memory channels coupled to a same semiconductor chip having multiple processing cores, the DRAM chips are acting as a cache for the nonvolatile memory chips that they share a same channel with rather than as a last level CPU cache. Although the above example refers to packaging solutions that include DIMM cards, it is pertinent to note that this is only one example and other embodiments may use other packaging solutions (e.g., stacked chip technology, one or more DRAM and phase change memories integrated on a same semiconductor die or at least within a same package as the processing core(s), etc.).

Reference to memory devices can apply to different memory types. Memory devices generally refer to volatile memory technologies. Volatile memory is memory whose state (and therefore the data stored on it) is indeterminate if power is interrupted to the device. Non-volatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM).

In addition to, or alternatively to, volatile memory, in one embodiment, reference to memory devices can refer to a non-volatile memory device whose state is determinate even if power is interrupted to the device. In one embodiment, the non-volatile memory device is a block addressable memory device, such as NAND or NOR technologies. Thus, a memory device can also include a future generation non-volatile devices, such as a three-dimensional crosspoint memory device, or other byte addressable non-volatile memory devices. In one embodiment, the memory device can be or include multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

Descriptions herein referring to a “DRAM” can apply to any memory device that allows random access, whether volatile or non-volatile. The memory device or DRAM can refer to the die itself and/or to a packaged memory product.

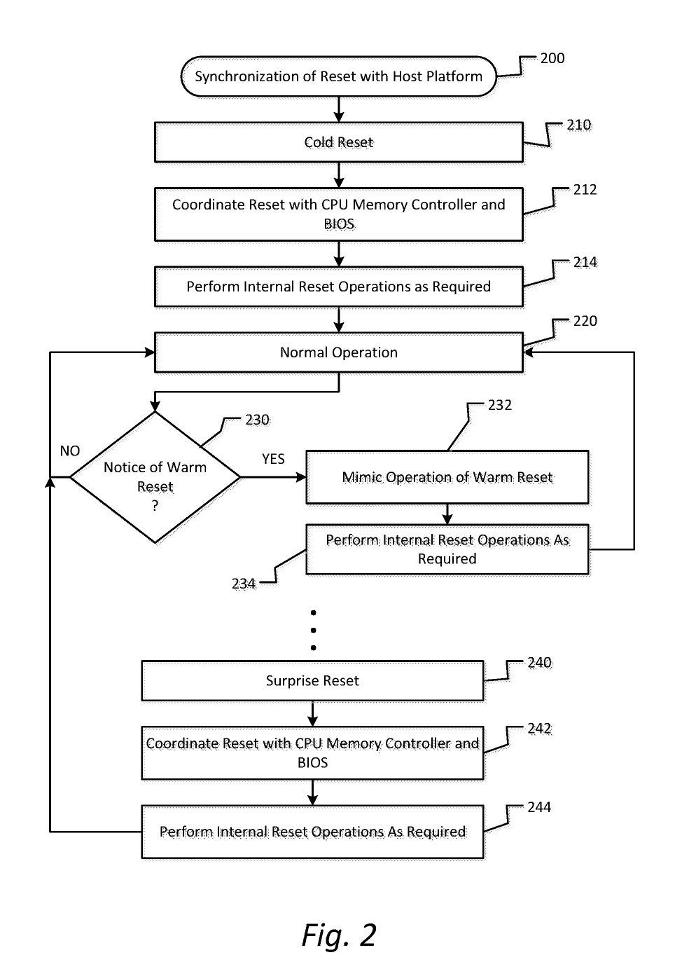

FIG. 2 is a flowchart to illustrate a process for support of host reset by a memory module according to an embodiment. In some embodiments, a process for synchronization of a memory module with reset operation for a host platform 200 includes support for cold reset, warm reset, and surprise reset operation of the host platform.

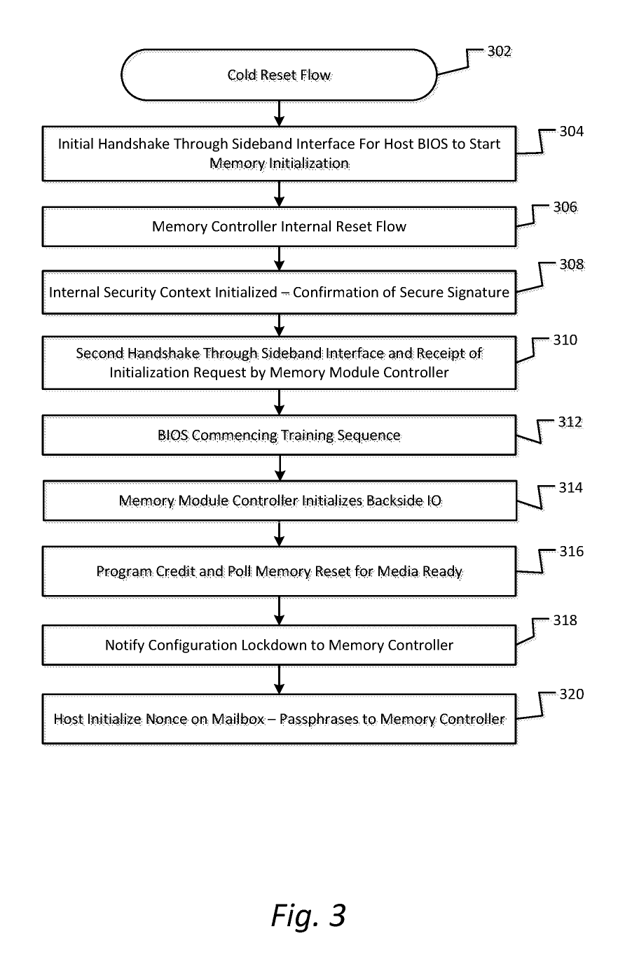

In some embodiments, upon a host platform reset 210, the memory module is to coordinate reset with the CPU memory controller 212 while performing required internal reset operations for the memory module 214. An exemplary cold reset process is further illustrated in FIG. 3.

In some embodiments, following the cold reset operation, the memory module will generally enter normal operation 220, wherein normal operation may include both operation in a first mode as ordinary volatile memory or operation in a second mode as non-volatile memory.

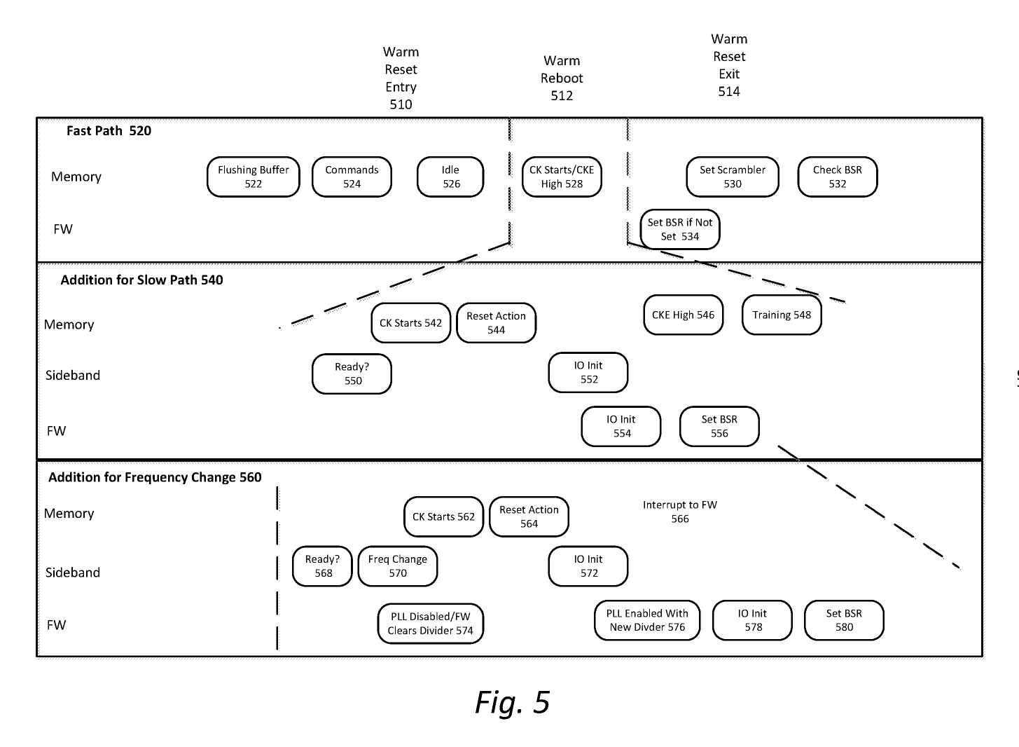

In some embodiments, upon receiving a notice of a warm reset 230, the memory module operates to mimic the operation of the particular warm reset 232 and perform internal reset operations as required 234. Exemplary warm reset processes are further illustrated in FIG. 5. In some embodiments, following the warm reset process and any internal reset process, the memory module will generally return to normal operation 220.

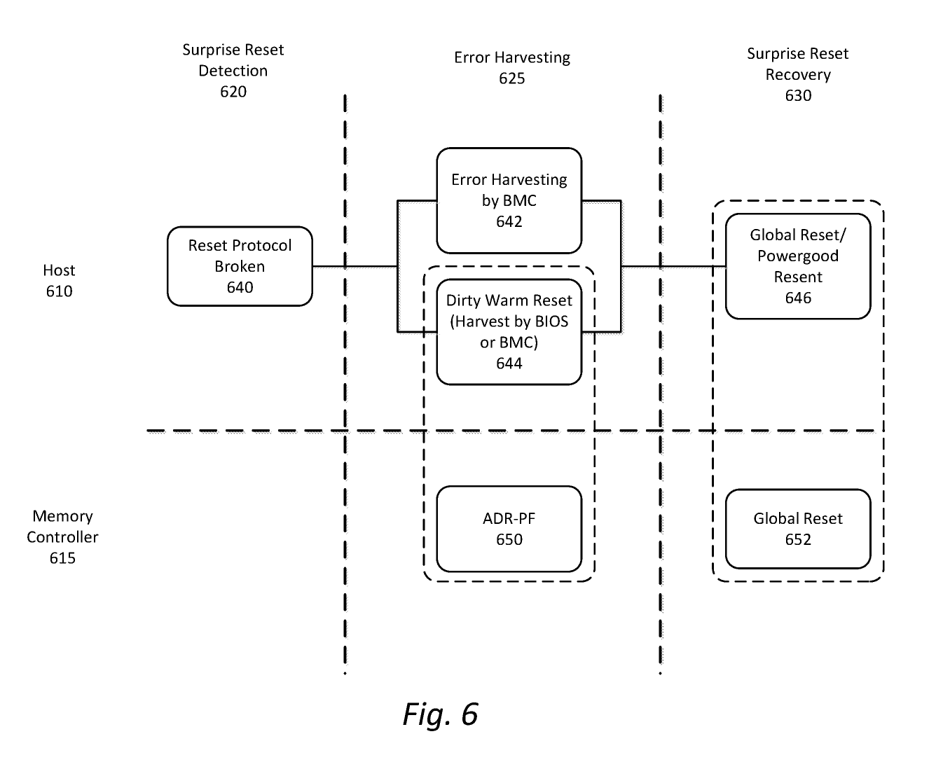

In some embodiments, at any point in operation, upon the occurrence of a platform surprise reset 240, the memory module is to coordinate reset with the CPU memory controller 242 while performing required internal reset operations for the memory module 244. An exemplary surprise reset process is further illustrated in FIG. 6. In some embodiments, following the surprise reset process and any internal reset process, the memory module will generally return to normal operation 220.

FIG. 3 is an illustration of cold reset operation by a memory module according to an embodiment. FIG. 3 illustrates an example of cold reset operation, but embodiments are not limited to these particular processors or the illustrated order of operations. In some embodiments, flow interaction between a memory module and a host platform for a host cold reset operation 302 may include, but is not limited to:

Block 304: Initial communications and negotiation between the memory module and host platform, which may include initial handshaking through a sideband interface, such as, for example, the system management bus (SMBus), with the platform BIOS, commencing memory module initialization. However, embodiments are not limited to any particular interface between the memory module and the host platform.

Block 306: Memory module controller to perform internal reset operation, such as the memory module controller to progress through internal reset flow, which may include the internal reset operation being performed while the status of the memory module is being polled by the platform BIOS.

Block 308: Security operation by the memory, including, but not limited to, initialization of an internal security context, with firmware confirming a secure signature of an image of the memory. A secure signature is a data form to demonstrate the authenticity of the image, and may include any known digital signature technology.

Block 310: Continued communications and negotiation between the memory module and the platform BIOS, such as a second handshake of the memory module with the platform BIOS through a sideband interface, such as the SMBus or other channel, and receipt of initialization request, allowing the memory module controller to initialize IO. In some embodiments, a secure mailbox mechanism is defined for the BIOS for use in the transaction, where a secure mailbox is a mechanism to limit data access to authorized entities, thereby providing security against attacks that may occur during the reset process. The secure mailbox may include any known technology to provide for secure receipt and handling of messaging between entities.

Block 312: BIOS may continue with initial operations, may include commencing any tuning or training sequence for memory channels as applicable for the memory. Training may include, but is not limited to, training to adjust timing and voltage to enhance performance.

Block 314: Memory module controller initializes the backside IO, non-volatile memory (NVM) IO, of the memory module, which is hidden to BIOS until media ready check-point. The media ready check-point is a status code or similar element indicating that a certain media such as the memory module is initialized.

Block 316: BIOS programs credit for both sides and polls the reset status of the memory module for media ready indicating that the memory module is ready for operation.

Block 318: Once media ready is confirmed, BIOS notifies configuration lock down to memory module controller, which may be presented and received by the memory module controller using, for example, a secure mail box. In some embodiments, the controller may save necessary configuration values for later use on exit from a sleep state or other reduced power state in which context data is lost. In some embodiments, the configuration lock indication is to further set a Surprise reset qualifier on the memory module.

Block 320: Host may further proceed to initialize a nonce (which is in general is a bit string that is used only once) on the secure mailbox, the memory module controller to receive passphrases from the host, allowing the memory module controller to derive encryption keys based on the nonce and passphrases to set up applicable security features.

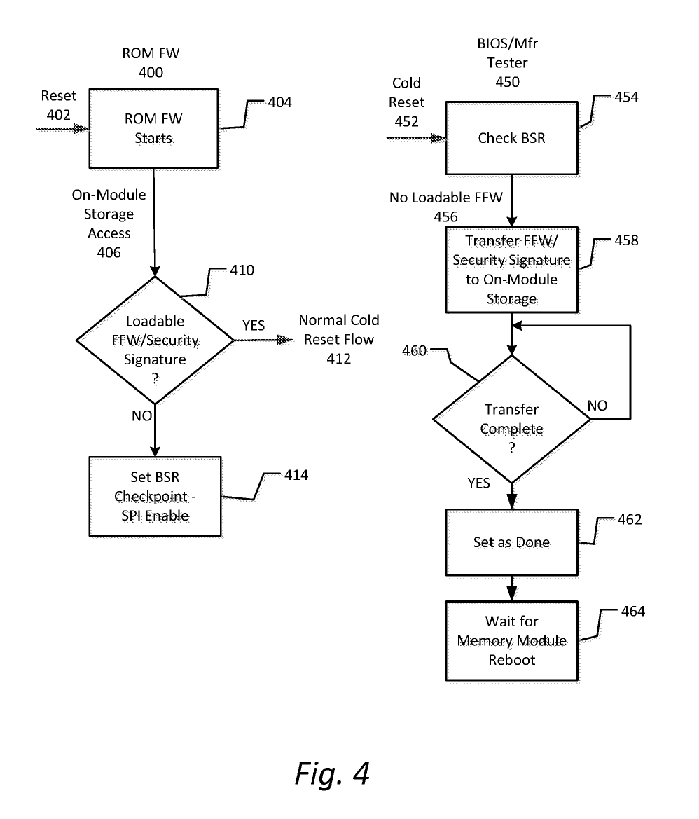

FIG. 4 illustrates download of firmware for a memory module according to an embodiment. In some embodiments, a special flow at the early stage of this cold reset for the host platform exists to download the memory module controller firmware in circumstances in which the memory module controller is unable to locate the correct firmware from on-module storage, such as, for example, the on-module SPI (serial peripheral interface). In some embodiments, the process utilizes an interface tunneled to the on-module storage. Processes may include, but are not limited to, the following:

In some embodiments, upon receipt of a reset 402, ROM firmware starts 404, and, utilizing on-module storage access 406, determines if loadable firmware/and security signature are available 410 and, if so, a normal cold reset flow follows 412. If not, then a BSR (Boot Status Register) checkpoint is set, with a default value coming from a fuse 414.

At the BIOS or a manufacturer tester 450, upon receiving notice of a cold reset 452, there is a check of the BSR 454. If there is currently no loadable firmware, then the firmware/security password are transferred to the SPI, wherein the process may loop until an end of transfer 460. A DONE bit may then then be set 462, followed by a wait for a memory module reboot 646.

When the host sets the DONE bit on the memory module controller, this triggers reset to the internal system on chip so that it will reboot firmware from SPI with the new firmware image and security password. By rebooting, the firmware is able to confirm the secure signature of the image again.

FIG. 5 is an illustration of warm reset support by a memory module according to an embodiment. As illustrated in FIG. 5, a flow is provided for warm reset entry 510, warm reboot 512, and warm reset exit 514. FIG. 5 illustrates possible processes for three different types of platform warm resets, the resets being a fast path reset 520 (illustrating memory module (Memory) and firmware (FW) processes), a slow path reset 540 (memory module, sideband, and firmware processes), and a frequency change reset 560 (memory module, sideband, and firmware processes). In some embodiments, during such processes the memory module is not going through the host platform reset processes, but rather is mimicking the behavior for the warm reset to the host platform. The processes of FIG. 5 can be used for transaction based DDR interface memories. In some embodiments, the processes may include, but are not limited to:

For in a warm reset entry 510 for each type of warm reset, the memory module controller may provide for flushing buffers for the temporary storage of data being transferred to or from memory 522, followed by certain commands for the reset process 524 and an idle operation (to hold operation in an idle state) 526. In a warm reboot 512 for the fast path warm reset 520, the clock (CK—clock provided by the CPU memory controller) starts and the clock enable (CKE—the qualifying signal for CK) signal is set high 528. When CKE is not active, the DIMM IO is in an idle state even when the CK signal is already running. Both CK and CKE signals stops (are de-activated) when the platform goes through reset, and thus the memory module controller needs to be able to deal with such situation even through it itself is not going through reset.

For the firmware, the BSR (Boot Status Register) is set if not already set 534, and the warm reset exit 514 includes setting a scrambler for memory operation 530 and checking for the BSR 532.

For the slow path warm reset 540, there may be in addition for the warm reboot 512 the memory controller processes of the clock (CK) starting 542, reset action 544, followed by the clock enable (CKE) being set high 546, and any memory training operation (such as training to adjust timing and voltage for improved performance) 548. In addition, for a sideband channel, upon determining ready status 550, the IO is initiated 552. For the firmware, there is IO initiation 554 and setting of the BSR 556. For example, reset action 544 can be a transaction based DDR Reset_N pulse, IO init 552 can be DDR IO init command, IO init 554 can be a DDR IO init, and training 548 can be DDR training.

For the frequency change reset 560, there may be, in addition for the warm reboot 512, the memory controller processes of the clock starting 564, a reset action 564, followed by an interrupt to the firmware 566. In addition, for a sideband channel, upon determining ready status 568, there is a frequency change 570 and the IO is initiated 572. For the firmware, there may be operation for the phase lock loop (PLL) used by the sideband channel to be disabled and the firmware to clear the clock divider 574 used by the sideband channel. This may be followed by the PLL being enabled with a new divider 576, and IO initiation 578 and setting of the BSR 580.

In some embodiments, the memory module operations for each of the warm reboot paths (fast path 520, slow path 540, and frequency change 560), the processes for the memory (522-526 and 530-532 for each of the paths; 528 for fast path 520; 542-548 for slow path 540; and 562-566 for frequency change 560) are performed to mimic the operation of a memory module in a warm reset process, the memory module to provide signals to the CPU memory controller in the same manner as a memory device that is proceeding through a reset operation without the memory module performing the actual reset flow. However, the memory module performs the flow illustrated in FIGS. 3-6.

FIG. 6 is an illustration of surprise reset support by a memory module according to an embodiment. As illustrated in FIG. 6, processes provided for the host platform 610 and the memory module controller 620 may include, but are not limited to, the following:

Surprise reset detection 620 for the host platform 610, wherein the reset protocol is broken 640. In some embodiments, a surprise reset includes the detection of an error condition that requires the reboot of the host platform, where the error condition may include, but are not limited to, hardware failure, operating system problems, program or software problems, memory failure, malware (malicious software) or other improper code, and power disruptions.

Error harvesting 625, including, for the host platform 610, error harvesting by the BMC (Baseboard Management Controller, the BMC being a processor or microcontroller to monitor a physical state of the host platform) and a dirty warm reset (dirty referring to the existence of buffered data that has not been written to storage) resulting from harvest by the BIOS or the BMC 644; and, for the memory module controller 615, receipt of an ADR-PF (ADR: Asynchronous DRAM Refresh, a hardware interrupt to flush data buffers and place DRAM in self-refresh; PF: Power Fail) or similar command. In some embodiments, the integrated memory controller (iMC) of the processor, with signaling by Pcode (microcode run on dedicated microcontroller within a power control unit), initiates ADR flow prior to warm reboot. In some embodiments, the memory controller ADR flow is to initiate shutdown flow on PLI (Power Loss Imminent) technology storage. In some embodiments, during the BMC error harvesting without dirty warm reset, the memory controller is to stay idle other than for CSR (Configuration Space Register) read.

Surprise reset recovery 630, including, for the host platform 610, global reset and powergood reset, and, for the memory module controller 615, a global reset 652. In some embodiments, a powergood (CPU-only powergood) reset may require another indication from the host platform.

In some embodiments, the memory module controller includes a special mode of deferring shutdown on PF (Power Fail) notification from the host (during the error Harvesting period, as illustrated in FIG. 6) so that the memory module controller can support error harvesting. In contrast, a normal PF notification will conventionally result in shutdown of a DIMM controller. During surprise reset recovery, the host may have a global reset that results in cold reset on the memory module or a powergood reset that does not involve any reset on the memory. In some embodiments, when powergood reset does not involve any reset on the memory, the memory module controller is to follow the slow path warm reset (for example, as illustrated as slow path 540 in FIG. 5) but without actual reset on the memory module controller. In some embodiments, slow path warm reset flow on the memory module controller is defined in a manner to support Surprise reset with powergood reset without additional impact or change on the host platform.

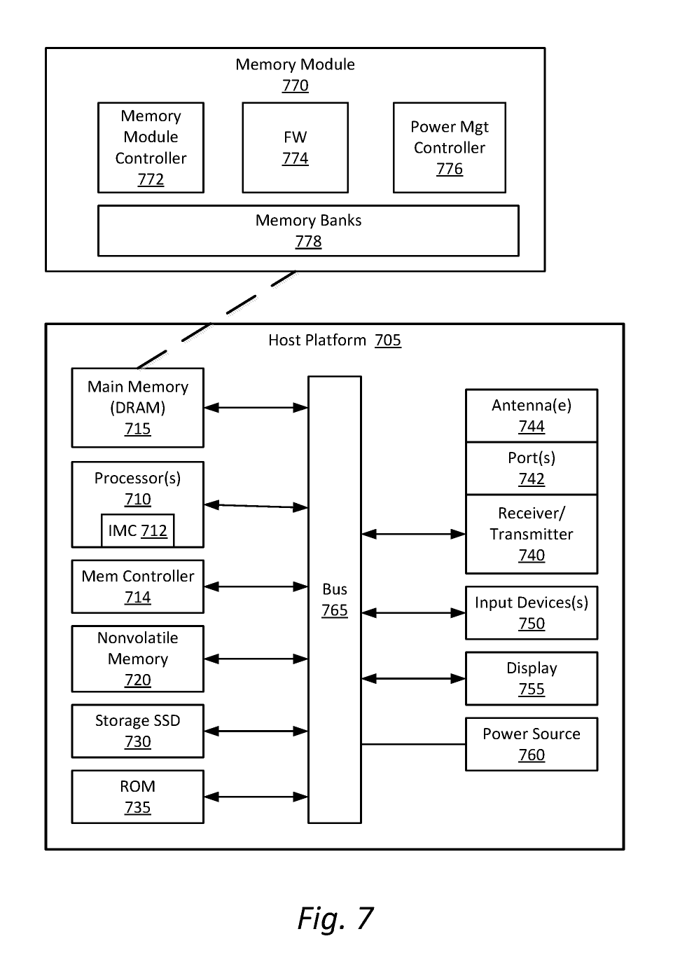

FIG. 7 is an illustration of a system including a memory to support host reset according to an embodiment. Elements shown as separate elements may be combined, including, for example, an SoC (System on Chip) combining multiple elements on a single chip.

In some embodiments, the host platform 705 may include a processing means such as one or more processors 710 coupled to one or more buses or interconnects, shown in general as bus 765. The processors 710 may comprise one or more physical processors and one or more logical processors. In some embodiments, the processors may include one or more general-purpose processors or special-processor processors. In some embodiments, the processors include a memory controller (iMC—integrated memory controller) 712. In some embodiments, a memory controller 714 may alternatively or additionally be an element separate from one or more processor 710.

The bus 765 is a communication means for transmission of data. The bus 765 is illustrated as a single bus for simplicity, but may represent multiple different interconnects or buses and the component connections to such interconnects or buses may vary. The bus 765 shown in FIG. 7 is an abstraction that represents any one or more separate physical buses, point-to-point connections, or both connected by appropriate bridges, adapters, or controllers.

In some embodiments, the host platform 705 further comprises a random access memory (RAM) or other dynamic storage device or element as a main memory 715 for storing information and instructions to be executed by the processors 710. Main memory 715 may include a smart memory module 770, which may include, but is not limited to, a memory module controller 772, firmware 774, a power management controller 776, and memory banks 778. In some embodiments, the memory module controller is operable to support reset operations of the host platform 705, such as illustrated in FIGS. 1-6. In some embodiments, the smart memory module provides transparent support for platform reset in each of a plurality of memory operation modes, such as the following memory operation modes:

(1) A first mode to provide volatile memory operation;

(2) A second mode to provide non-volatile main memory operation; and

(3) A third mode to provide non-volatile memory in a storage device operation.

The host platform 705 also may comprise a non-volatile memory 720; a storage device such as a solid state drive (SSD) 730; and a read only memory (ROM) 735 or other static storage device for storing static information and instructions for the processors 710.

In some embodiments, the host platform 705 includes one or more transmitters or receivers 740 coupled to the bus 765. In some embodiments, the host platform 705 may include one or more antennae 744, such as dipole or monopole antennae, for the transmission and reception of data via wireless communication using a wireless transmitter, receiver, or both, and one or more ports 742 for the transmission and reception of data via wired communications. Wireless communication includes, but is not limited to, Wi-Fi, Bluetooth™, near field communication, and other wireless communication standards.

In some embodiments, host platform 705 includes one or more input devices 750 for the input of data, including hard and soft buttons, a joy stick, a mouse or other pointing device, a keyboard, voice command system, or gesture recognition system.

In some embodiments, the host platform 705 includes an output display 755, where the display 755 may include a liquid crystal display (LCD) or any other display technology, for displaying information or content to a user. In some environments, the display 755 may include a touch-screen that is also utilized as at least a part of an input device 750. Output display 755 may further include audio output, including one or more speakers, audio output jacks, or other audio, and other output to the user.

The system 700 may also comprise a battery or other power source 760, which may include a solar cell, a fuel cell, a charged capacitor, near field inductive coupling, or other system or device for providing or generating power in the host platform 705. The power provided by the power source 760 may be distributed as required to elements of the host platform 705.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, a memory module includes a memory module controller; and one or more memory banks, wherein the memory module controller is to perform one or more internal reset processes as required for the memory module; and wherein the memory module controller is to support a plurality of host platform reset processes to synchronize with the host platform.

In some embodiments, the plurality of host platform reset processes include: a cold reset; a warm reset; and a surprise reset.

In some embodiments, the support of the warm reset by the memory module includes communication of performance of the warm reset to the host platform without performance of the warm reset by the memory module.

In some embodiments, support of a warm reset by the memory module includes support for each type of warm reset process for the host platform.

In some embodiments, the memory module is to support a plurality of memory operation modes, and is to support each of the platform reset processes for each of the plurality of memory operation modes. In some embodiments, the plurality of memory operation modes includes a first mode to provide volatile memory operation; a second mode to provide non-volatile main memory operation; and a third mode to provide storage device operation.

In some embodiments, wherein supporting a plurality of host platform reset processes includes interacting with a CPU (central processor unit) memory controller and a BIOS (basic input output system) MRC (memory resource code).

In some embodiments, the memory module further includes firmware to provide instructions for memory operation, including a reset operation.

In some embodiments, the memory module further includes a power management controller to provide power management operation for the memory module, including power control in a reset operation.

In some embodiments, a system includes a processor including a memory controller; memory including a smart memory module; and a transmitter and receiver for transmission of data, and an antenna for the wireless transmission of data, wherein the smart memory module includes a memory module controller, and one or more memory banks, wherein the memory module controller is to perform one or more internal reset processes as required for the smart memory module; and wherein the memory module controller is to support a plurality of host platform reset processes to synchronize with the processor of the system.

In some embodiments, the plurality of host platform reset processes include a cold reset; a warm reset; and a surprise reset.

In some embodiments, the support of the warm reset by the smart memory module includes communication of performance of the warm reset without performance of the warm reset by the smart memory module

In some embodiments, support of a warm reset by the smart memory module includes support for each of a plurality of types of warm reset processes. In some embodiments, the plurality of types of warm reset processes include a fast path warm reset, a slow path warm reset, and frequency change warm reset.

In some embodiments, the smart memory module is to support a plurality of memory operation modes, and is to support each of the platform reset processes for each of the plurality of memory operation modes. In some embodiments, the plurality of memory operation modes includes a first mode to provide volatile memory operation; a second mode to provide non-volatile main memory operation; and a third mode to provide storage device operation.

In some embodiments, supporting a plurality of host platform reset processes includes interacting with the processor memory controller and a BIOS (basic input output system) MRC (memory resource code).

In some embodiments, the smart memory module further includes firmware to provide instructions for memory operation, including a reset operation.

In some embodiments, the smart memory module further includes a power management controller to provide power management operation for the memory module, including power control in a reset operation.

In some embodiments, at least one non-transitory computer-readable storage medium having stored thereon data representing sequences of instructions that, when executed by a processor, cause the processor to perform operations including receiving a notification of a host platform reset process at a memory module, the reset process being one of a plurality of reset processes for the host platform; performing operations to coordinate with the host platform in the host platform reset process; and performing one or more internal reset processes as required for the memory module.

In some embodiments, the plurality of host platform reset processes include a cold reset; a warm reset; and a surprise reset.

In some embodiments, performing operations to synchronize with the host platform in the warm reset includes communication of performance of the warm reset to the host platform without performance of the warm reset by the memory module.

In some embodiments, performing operations to synchronize with the host platform in the warm reset includes operations for any of a plurality of types of warm reset processes for the host platform.

In some embodiments, performing operations to coordinate with the host platform in the host platform reset process includes supporting each of the host platform reset processes for each of a plurality of memory operation modes. In some embodiments, the plurality of memory operation modes includes a first mode to provide volatile memory operation; a second mode to provide non-volatile main memory operation; and a third mode to provide storage device operation.

In some embodiments, the instructions further include instructions for interacting with the processor memory controller and a BIOS (basic input output system) MRC (memory resource code).

In some embodiments, the memory module includes firmware to provide instructions for memory operation, including a reset operation.

What is claimed is:

1. A memory module comprising:
a memory module controller; and
one or more memory banks;
wherein the memory module controller is to perform one or more internal reset processes as required for the memory module; and
wherein the memory module controller is to support a plurality of host platform reset processes to synchronize with the host platform.

2. The memory module of claim 1, wherein the plurality of host platform reset processes include:
a cold reset;
a warm reset; and
a surprise reset.

3. The memory module of claim 2, wherein the support of the warm reset by the memory module includes communication of performance of the warm reset to the host platform without performance of the warm reset by the memory module.

4. The memory module of claim 2, wherein support of a warm reset by the memory module includes support for each type of warm reset process for the host platform.

5. The memory module of claim 2, wherein the memory module is to support a plurality of memory operation modes, and is to support each of the platform reset processes for each of the plurality of memory operation modes.

6. The memory module of claim 5, wherein the plurality of memory operation modes includes;
a first mode to provide volatile memory operation;
a second mode to provide non-volatile main memory operation; and
a third mode to provide storage device operation.

7. The memory module of claim 1, wherein support of a plurality of host platform reset processes includes interaction with a CPU (central processor unit) memory controller and a BIOS (basic input output system) MRC (memory resource code).

8. The memory module of claim 1, further comprising firmware to provide instructions for memory operation, including a reset operation.

9. The memory module of claim 1, further comprising a power management controller to provide power management operation for the memory module, including power control in a reset operation.

10. A system comprising:
a processor including a memory controller;
memory including a smart memory module; and
a transmitter and receiver for transmission of data, and an antenna for the wireless transmission of data;
wherein the smart memory module includes:
a memory module controller, and
one or more memory banks;
wherein the memory module controller is to perform one or more internal reset processes as required for the smart memory module; and
wherein the memory module controller is to support a plurality of host platform reset processes to synchronize with the processor of the system.

11. The system of claim 10, wherein the plurality of host platform reset processes include:
a cold reset;
a warm reset; and
a surprise reset.

12. The system of claim 11, wherein the support of the warm reset by the smart memory module includes communication of performance of the warm reset without performance of the warm reset by the smart memory module.

13. The system of claim 11, wherein support of a warm reset by the smart memory module includes support for each of a plurality of types of warm reset processes.

14. The system of claim 13, wherein the plurality of types of warm reset processes include a fast path warm reset, a slow path warm reset, and frequency change warm reset.

15. The system of claim 11, wherein the smart memory module is to support a plurality of memory operation modes, and is to support each of the platform reset processes for each of the plurality of memory operation modes.

16. The system of claim 15, wherein the plurality of memory operation modes include:
a first mode to provide volatile memory operation;
a second mode to provide non-volatile main memory operation; and
a third mode to provide storage device operation.

17. The system of claim 10, wherein support a plurality of host platform reset processes includes interaction with the processor memory controller and a BIOS (basic input output system) MRC (memory resource code).

18. The system of claim 10, wherein the smart memory module further includes firmware to provide instructions for memory operation, including a reset operation.

19. The system of claim 10, wherein the smart memory module further includes a power management controller to provide power management operation for the smart memory module, including power control in a reset operation.

20. At least one non-transitory computer-readable storage medium having stored thereon data representing sequences of instructions that, when executed by at least one processor, cause the processor to perform operations comprising:
receiving a notification of a host platform reset process at a memory module, the reset process being one of a plurality of reset processes for the host platform;
performing operations to coordinate with the host platform in the host platform reset process; and
performing one or more internal reset processes as required for the memory module.

21. The medium of claim 20, wherein the plurality of host platform reset processes include:
a cold reset;
a warm reset; and
a surprise reset.

22. The medium of claim 21, wherein performing operations to synchronize with the host platform in the warm reset includes communication of performance of the warm reset to the host platform without performance of the warm reset by the memory module.

23. The medium of claim 21, wherein performing operations to synchronize with the host platform in the warm reset includes operations for any of a plurality of types of warm reset processes for the host platform.

24. The medium of claim 21, wherein performing operations to coordinate with the host platform in the host platform reset process includes supporting each of the host platform reset processes for each of a plurality of memory operation modes.

25. The medium of claim 24, wherein the plurality of memory operation modes includes;
a first mode to provide volatile memory operation;
a second mode to provide non-volatile main memory operation; and
a third mode to provide storage device operation.

26. The medium of claim 20, further comprising instructions that, when executed by the processor, cause the processor to perform operations comprising:
interacting with the processor memory controller and a BIOS (basic input output system) MRC (memory resource code).

27. The medium of claim 20, wherein the memory module includes firmware to provide instructions for memory operation, including a reset operation.
